(19) United States
(12) Patent Application Publication
(10) Pub. No.: US 2024/0402956 A1
(43) Pub. Date: Dec. 5, 2024

(54) CONTROLLING APPARATUS, METHOD OF CONTROLLING DEVICE, AND STORAGE MEDIUM

(71) Applicant: CANON KABUSHIKI KAISHA, Tokyo (JP)

(72) Inventor: ASUKA TASAKI, Tokyo (JP)

(21) Appl. No.: 18/654,237

(22) Filed: May 3, 2024

(30) Foreign Application Priority Data
May 31, 2023 (JP) 2023-089747

(51) Int. Cl. G06F 3/12

(52) U.S. Cl. CPC G06F 3/1229; G06F 3/121; G06F 3/1286

(57) ABSTRACT

A controlling apparatus according to the present disclosure is a controlling apparatus for controlling a device provided with a warning period before starting an action, the controlling apparatus including an acceptance unit configured to accept an instruction to start the action; and a changing unit configured to change the warning period in accordance with a situation under which the action is executed.

### BACKGROUND OF THE INVENTION

### Field of the Invention

The present disclosure relates to a controlling apparatus, a method of controlling a device, and a storage medium.

### Description of the Related Art

Conventionally, in starting the action of a machine, it has been required to improve safety by double checking to prevent malfunction. It is also required that a warning period of two seconds or more and a permissive period of six seconds or less be provided before the start of the action. These requirements are stipulated in the international standard ISO12643-1 (hereinafter referred to as device safety regulations) (Literatures 1 and 2).

Literature 1 (ISO 12643-1: 2009 (E), Page. 64, Item 14.2.2 Warning period) discloses as follows. “The warning period shall end not less than 2 s after depressing a motion control. Machine motion shall not occur during the warning period. Machine motion may occur at the end of the warning period.” “At the end of the warning period, one of the following two procedures is permitted:” “a) The following “double push” sequence is preferred. At the end of the warning period, machine motion will occur as the result of releasing a motion control during or after the warning period, and reactivating a motion control during the permissive period”;
“b) Alternatively, machine motion will occur as the result of holding a motion control through and beyond the warning period.”

Literature 2 (ISO 12643-1: 2009 (E), Page. 64, Annex C Area-light warning system, Items C.2 and C.3) discloses as follows. “The warning period is initiated by clearing all stop/safe pushbuttons and by depressing a motion control and ends not less than 2 s later. Actuation of a motion control prior to the completion of the warning period shall not induce machine motion.” “The permissive period is a period of not more than 6 s which is initiated after completion of a full warning period.” “At the end of the permissive period, the system automatically reverts to a ready condition.”

However, for example, in an industrial printer, there are many items to check before execution of printing, and depending on the situation, there is a possibility that there is a shortage of time for checking in a case of using a predetermined warning period. Examples of items to check include whether the safety of a worker around a device is ensured, whether a job to be executed is appropriate, and whether there are sufficient quantities of inks and sheets. Thus, it is necessary to ensure a sufficient quantity of check time.

The present disclosure aims to improve safety at the start of a device action in compliance with the device safety regulations.

### SUMMARY OF THE INVENTION

A controlling apparatus according to the present disclosure is a controlling apparatus for controlling a device provided with a warning period before starting an action, the controlling apparatus including an acceptance unit configured to accept an instruction to start the action; and a changing unit configured to change the warning period in accordance with a situation under which the action is executed.

Further features of the present invention will become apparent from the following description of exemplary embodiments with reference to the attached drawings.

### BRIEF DESCRIPTION OF THE DRAWINGS

FIG. 1 is a diagram showing a device configuration of an image forming system;

FIG. 2 is a block diagram showing a basic functional configuration of the image forming system;

FIG. 3 is a block diagram showing a configuration of the function of changing a warning period;

FIG. 4 is a table showing examples of factors and specific situations that change the warning period;

FIG. 5 is a flowchart showing the flow of processing executed at the time of a print start button being operated;

FIG. 6 is a diagram showing an example of a print execution check screen;

FIG. 7 is a flowchart showing the flow of processing for determining time required for the warning period;

FIGS. 8A to 8C are time charts showing the warning period and a permissive period;

FIG. 9 is a flowchart showing the flow of processing during the warning period;

FIG. 10 is a flowchart showing the flow of processing during the permissive period;

FIGS. 11A to 11D are diagrams for explaining synchronization between a rotary warning lamp and screen display;

FIG. 12 is a diagram showing an example of an operator state setting screen;

FIG. 13 is a flowchart showing the flow of processing executed at the time of the print start button being operated from a remote terminal;

FIG. 14 is a diagram showing an example of the print execution check screen from a remote UI; and

FIG. 15 is a flowchart showing the flow of processing executed at the time of a sheet conveyance instruction being input.

### DESCRIPTION OF THE EMBODIMENTS

The embodiments described below do not limit contents recited in the claims. In the following embodiments, descriptions will be given of, as an example, an image forming system used as an industrial printer, but the scope of the claims for a patent is not limited to industrial printers. Further, not all of the configurations described in the present embodiments are essential constituents.

### First Embodiment

A first embodiment will be described below.

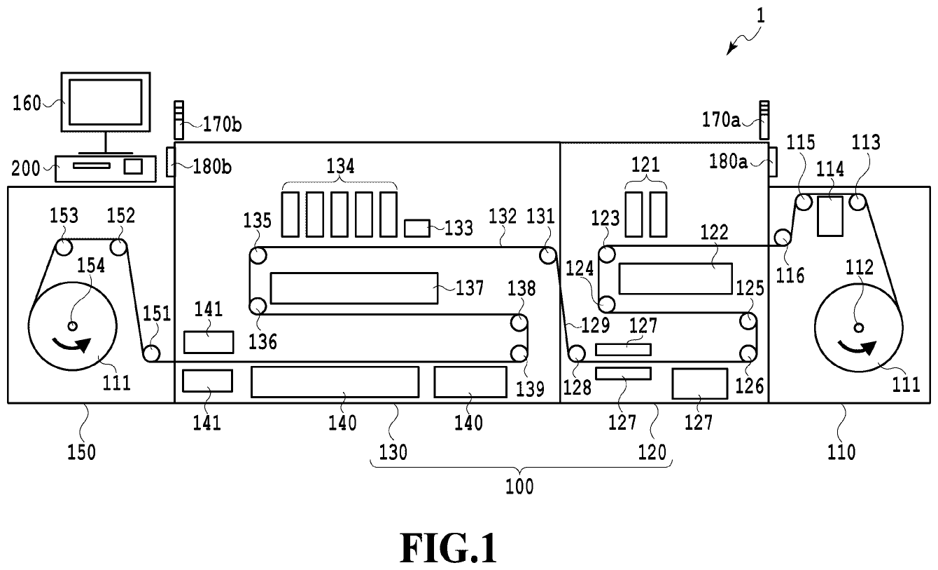

FIG. 1 is a diagram showing an example of the device configuration of an image forming system 1 according to the present embodiment. As shown in FIG. 1, the image forming system 1 includes an image forming device 100, a sheet feed device 110, a sheet discharge device 150, a control PC 200, and an operation panel 160. The image forming device 100 includes a special color printing unit 120 and a basic color printing unit 130. The image forming system 1 includes rotary warning lamps 170a and 170b and buzzers 180a and 180b for sending a notice of warnings.

The sheet feed device 110 is a device supplying a roll sheet 111 to the image forming device 100. The roll sheet 111 is a continuous sheet on which continuous image forming can be performed, and is wound around a core material such as a paper tube. The sheet feed device 110 rotates the core material of the roll sheet 111 around a rotating shaft 112 by a drive motor and conveys the roll sheet 111 wound around the core material via a plurality of rollers 113, 115, 116 toward the image forming device 100 at a constant speed.

The special color printing unit 120 of the image forming device 100 is a printing unit that forms an image on the roll sheet 111 using a special color ink (such as a white ink) other than print basic color (CMYK) inks. The basic color printing unit 130 is a printing unit that forms an image on the roll sheet 111 using the print basic color inks (CMYK).

The sheet discharge device 150 is a device that winds up the conveyed roll sheet 111 on which an image is formed by the image forming device 100 around a core material such as a paper tube.

Here, a conveyance path for conveying the roll sheet 111 in the image forming system 1 will be described.

Before starting printing, the roll sheet 111 is set by a worker from the sheet feed device 110 to the sheet discharge device 150. The roll sheet 111 set in the sheet feed device 110 is passed with the leading end of the roll sheet 111 first, via a roller 113, and over a skew correction device 114. After that, the roll sheet 111 is conveyed to the special color printing unit 120 of the image forming device 100 via the rollers 115, 116.

In the special color printing unit 120, the roll sheet 111 is conveyed under a printing device 121, via rollers 123, 124, and under a drying device 122. The roll sheet 111 is further conveyed to a cooling device 127 via rollers 125, 126. The roll sheet 111 is then conveyed to the basic color printing unit 130 via a roller 128 and a conveyance path 129.

In the basic color printing unit 130, the roll sheet 111 is conveyed via a roller 131 and a conveyance path 132 and below a mark detection sensor 133 and a printing device 134. The roll sheet 111 is then conveyed under a drying device 137 via rollers 135, 136.

The mark detection sensor 133 is a sensor for aligning an image formed on the roll sheet 111 by the printing device 121 of the special color printing unit 120 and an image formed on the roll sheet by the printing device 134 of the basic color printing unit 130. It should be noted that a scanner device may be provided in place of the mark detection sensor 131 to perform alignment using an image read by the scanner device.

After that, the roll sheet 111 is conveyed via rollers 138, 139, over a cooling device 140, through a scanner device 141, and to the sheet discharge device 150 after passing.

After being fed to the sheet discharge device 150, the roll sheet 111 is wound around a core material such as a sheet tube set on a rotating shaft 154 via rollers 151, 152, 153. The sheet discharge device 150 rotates the core material around the rotating shaft 154 by a driving motor and winds up the conveyed roll sheet 111 as a product.

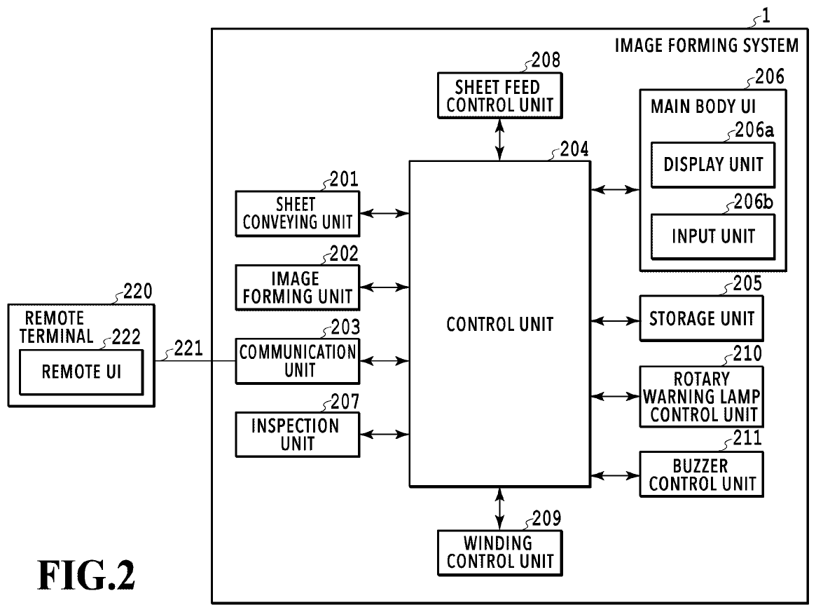

In a case where a print job is input to the control PC 200 from a remote terminal 220 shown in FIG. 2 in a state where the roll sheet 111 is passed through the inside of the image forming system 1 through the path as described above, the control PC 200 stores the print job in a job storage region of the storage unit 205. The job storage region may be provided in storage that is accessible via a network 221.

The control PC 200 is a computer terminal including a CPU, a ROM, a RAM, an operation portion I/F (interface), a device I/F, a communication I/F, and the like. The control PC 200 controls each unit of the image forming system 1 to execute a sheet feeding and discharging action, a printing action, a warning action, an inspection action, or the like. For example, in a case where an operator issues an instruction to start an action by, for example, operating a print start button on the operation panel 160, the control PC 200 controls driving of each unit of the image forming device 100, sheet feed device 110, and sheet discharge device 150 to start the printing action.

The control PC 200 controls driving of a rotary warning lamp 170 and a buzzer 180 in accordance with the state of the image forming system 1 to cause the warning action to be performed. In the image forming system 1 according to the present embodiment, a warning period of three seconds or more and a permissive period of six seconds or less are provided after the operator issues an instruction to execute an action. The warning action is performed by lighting/blinking the rotary warning lamps 170a, 170b, ringing the buzzers 180a, 180b, or the like. Details on the warning action will be described later.

The rotary warning lamps 170a, 170b are warning lights for making a visual notification of a warning and have, for example, red, yellow, and green (blue) segments. In the example of FIG. 1, the rotary warning lamp 170a is provided on the top surface of the image forming device 100 on the sheet feed device 110 side, and the rotary warning lamp 170b is provided on the top surface of the image forming device 100 on the sheet discharge device 150 side. Lighting, blinking, and extinguishing of each segment of the rotary warning lamps 170a, 170b are controlled by the control PC 200. The operator is notified of the state of the image forming system 1 (during error occurrence, during warning occurrence, during the warning period, being normally operated, or the like) based on the state of each segment being lighted, blinked, or extinguished.

The buzzers 180a, 180b are devices that audibly provide notification of a warning, and notify the operator of the state of the image forming system 1 by, for example, a plurality of ring patterns. The actions of the buzzers 180a, 180b are controlled by the CPU (control unit 204) of the control PC 200. In the example of FIG. 1, the buzzer 180a is provided on the side surface of the image forming device 100 on the sheet feed device 110 side, and the buzzer 180b is provided on the side surface of the image forming device 100 on the sheet discharge device 150 side.

In the following description, in a case where the individual rotary warning lamps 170a, 170b are not distinguished, each of them will be referred to as rotary warning lamp 170. Further, in a case where the individual buzzers 180a, 180b are not distinguished, each of them will be referred to as buzzer 180. The numbers of rotary warning lamps 170 and buzzers 180 installed are not limited to these examples, but are any numbers.

In a case where an image is formed on the roll sheet 111 by the printing action, the control PC 200 reads the image with the scanner device 141 in the image forming device 100 and sends the image to the control PC 200. The control PC 200 analyzes the image sent from the scanner device 141 and inspects a printed product for defects.

Next, the internal configuration of the image forming system 1 will be described.

FIG. 2 is a block diagram showing the basic functional configuration of the image forming system 1. The image forming system 1 includes a sheet conveying unit 201, an image forming unit 202, a communication unit 203, a control unit 204, a storage unit 205, a main body UI (user interface) 206, an inspection unit 207, a sheet feed control unit 208, a winding control unit 209 and the like. The image forming system 1 also includes a rotary warning lamp control unit 210 for providing notification of an alarm, a buzzer control unit 211, and the like.

The image forming system 1 is connected to a remote terminal 220 via the network 221 by the communication unit 203. The remote terminal 220 is an information processing terminal installed at a location remote from the main body of the image forming system 1. The remote terminal 220 includes, for example, a PC, a tablet, a smartphone, and the like provided with a CPU, a ROM, a RAM, a storage unit, a communication unit, a display unit, an input unit, and the like.

In a case where the control unit 204 of the image forming system 1 is accessed from the remote terminal 220, the control unit 204 performs a login process for the operator and then authorizes access from the remote terminal 220. While the operator logs in to the image forming system 1, a remote UI 222 is displayed on the display unit of the remote terminal 220.

The remote UI 222 is an operation screen displayed on the remote terminal 220 of the image forming system 1. As with the operation screen (main body UI 206) displayed on the operation panel 160 of the device main body, the remote UI 222 accepts input of an action instruction and various setting operations. Instructions and setting information input on the remote UI 222 are sent to the control PC 200 via the network 221, received by the communication unit 203, and input to the control unit 204. The control unit 204 sends data for UI screen display including information on the state of each device of the image forming system 1 and the like to the remote terminal 220 and causes the remote UI 222 to be displayed.

The main body UI 206 is an operation panel 160 provided in the device main body of the image forming system 1 and includes a display unit 206a and an operation unit 206b. The display unit 206a is an LCD display, an organic EL display, or the like. The display unit 206a displays various kinds of information including information on the state of the image forming system 1, setting values, and the like in accordance with a display control signal input from the control unit 204. The input unit 206b includes various hard keys such as a numeric keypad and a start key, and input equipment such as a touch panel. The input unit 206b accepts an input operation by an operator and outputs the input operation signal to the control unit 204.

The operator can set job information, give instructions to start a job, and the like from the main body UI 206 or the remote UI 222. Specifically, setting job information means setting conditions such as a sheet to use, information on printing speed, the number of sheets to be printed, the number of prints, printing lengths, printing weights, and printing diameters. The operator can optionally set these conditions. In the following description, in a case where the main body UI 206 and the remote UI 222 are not particularly distinguished, each of them will be referred to as UI screen.

The sheet conveying unit 201 is a conveyance mechanism that conveys the roll sheet 111 in the image forming device 100 and includes a plurality of rollers, a motor that drives the rollers, a conveyance path, and the like. The sheet conveying unit 201 conveys the roll sheet 111 fed from the sheet feed device 110 under the control of the sheet feed control unit 208 to the image forming unit 202 (image forming device 100). The sheet conveying unit 201 also conveys the roll sheet 111 that has passed through the image forming unit 202 (image forming device 100) to the sheet discharge device 150.

The sheet feed control unit 208 causes a drive motor provided on the rotating shaft 112 of the sheet feed device 110 and the like to act in accordance with a control signal sent from the control unit 204 and feeds the roll sheet 111 to the image forming unit 202 (image forming device 100).

The winding control unit 209 causes a drive motor provided on the rotating shaft 154 of the sheet discharge device 150 and the like to act in accordance with a control signal sent from the control unit 204 and winds the roll sheet 111 on which an image is formed by the image forming device 100 around the core material.

The image forming unit 202 causes each unit of the image forming device 100 (the special color printing unit 120, the basic color printing unit 130) to act in accordance with a control signal sent from the control unit 204 to form an image on the roll sheet 111 based on print data on the print job for which a print execution instruction has been received.

The communication unit 203 is, for example, a LAN (Local Area Network) card or the like and includes a communication control circuit, a communication port, and the like. The communication unit 203 establishes a communication connection with the remote terminal 220 connected to the network 221 such as a LAN or WAN (Wide Area Network) and sends and receives various kinds of data between the remote terminal 220 and the control PC 200.

The control unit 204 includes, for example, a CPU, a ROM, a RAM, and the like. The CPU of the control unit 204 reads various programs such as a system program and a processing program stored in the storage unit 205 or the ROM, expands the programs into the RAM, and executes various processes according to the expanded programs. The control unit 204 executes an action (print job) to form an image on the roll sheet 111 in accordance with an instruction input by the operator via the operation panel 160 or the remote UI 222.

The storage unit 205 includes, for example, a nonvolatile semiconductor memory (so-called flash memory), an HDD (hard disk drive), an SSD (solid state drive), and the like. The storage unit 205 stores various programs including a system program and a processing program executed by the control unit 204, and various kinds of data necessary for execution of these programs.

The control unit 204, the communication unit 203, and the storage unit 205 are provided in the control PC 200. It should be noted that a portion of the storage unit 205 may be provided in storage that can establish communication connection via the network 221.

The inspection unit 207 has the function of checking whether an image to be printed is successfully printed on the roll sheet 111 without defective ejection and includes inspection devices such as a scanner device and an analysis device. The inspection unit 207 checks whether there is any defective ejection in the printed image by printing a detection pattern for testing for defective ejection, reading the printed detection pattern with a scanner, and analyzing the read image. In a case where defective ejection is detected, the printing action of the image forming device 100 is stopped.

Methods of inspection by the inspection unit 207 include various methods, such as a method of directly reading a printed image with a camera or scanner to inspect the printed image and a method of monitoring the situation of ejection from a nozzle in addition to the method of printing a detection pattern to read it with a scanner. In the present embodiment, as an example, the method of printing a detection pattern to read it with a scanner is used to check whether there is defective ink ejection.

The rotary warning lamp control unit 210 lights, blinks, and extinguishes each color of the rotary warning lamp 170 based on a control signal sent from the control unit 204. For example, a blue light is lit during execution of a print job, a yellow light is lit during warning occurrence, a red light is lit during error occurrence, and the red light is blinked during a warning period and a permissive period after an action start instruction is input.

The buzzer control unit 211 rings the buzzer 180 based on a control signal sent from the control unit 204. For example, the buzzer 180 is used to sound a warning tone during warning occurrence, error occurrence, and a warning period.

Here, the warning period and permissive period in the image forming system 1 will be described.

The warning period and permissive period are the warning period and permissive period defined, for example, in ISO 12643-1 “Activation Sequence, Item 13.2.2” and ISO 12643-1 “Annex C, Region Warning Light System, Items C.2 and C.3.” In a case where a print start instruction is input via the UI screen in a standby state, the warning period starts. In the present embodiment, reference time for the warning period is three seconds. However, the control unit 204 changes (extends) the warning period depending on the situation under which the printing action is executed.

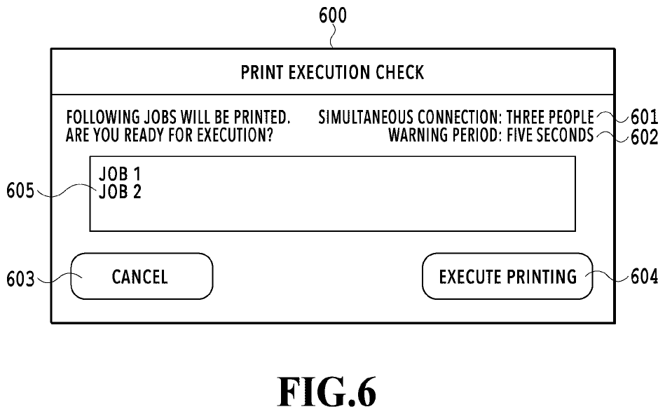

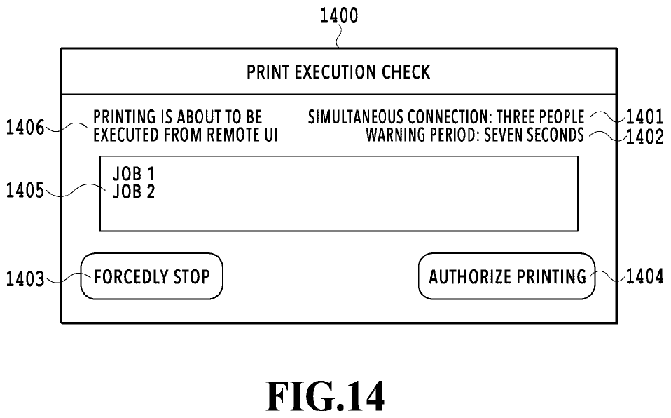

During the warning period, the control unit 204 does not accept the operation of an action execution button 604 provided on the UI screen (FIG. 6) but accepts the operation of a cancel button 603 or a forced stop button 1403 (FIG. 14). In a case where the cancel button 603 or the forced stop button 1403 is operated, the warning period is ended and the print instruction is canceled.

In a case where the warning period ends, the permissive period starts. The permissive period is, for example, six seconds. In a case where a second print start operation (operation of the action execution button 604) is input during the permissive period, the control unit 204 starts the printing action. In a case where the permissive period ends without the second print start operation being input during the permissive period, the image forming system 1 returns to the standby state.

Here, an image forming (printing) action in the image forming system 1 will be described. The operator creates print-job-related image data in the remote terminal 220, makes print settings and the setting of the number of volumes to be supplied, and sends the information to the image forming system 1 via the communication unit 203. The control unit 204 of the image forming system 1 accepts the print-job-related image data and a job ticket including the print setting information and the information on the number of volumes to be supplied sent from the remote terminal 220 via the communication unit 203. The control unit 204 associates the accepted job ticket with a job ID, saves it in the storage unit 205, and adds it to a job list.

The operator can display the job list on the UI screen by operating the UI screen (the main body UI 206 or the remote UI 222). The control unit 204 accepts job selection made by the operator on the UI screen and accepts input of a print start instruction by the print start button provided on the UI screen being operated.

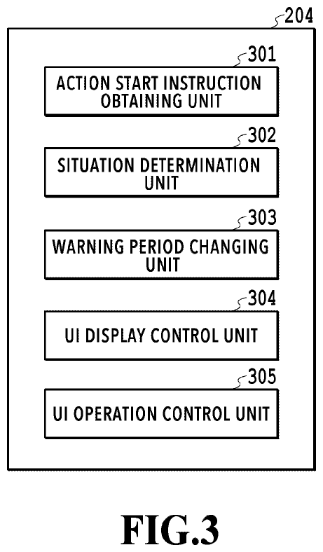

FIG. 3 is a block diagram showing the configuration of the function of changing the warning period after an instruction to start an action is input to the image forming system 1 and before starting the action. As shown in FIG. 3, the control unit 204 includes an action start instruction obtaining unit 301, a situation determination unit 302, a warning period changing unit 303, a UI display control unit 304, a UI operation control unit 305, and the like.

The action start instruction obtaining unit 301 obtains an action start instruction input to the image forming system 1 via the UI screen. In the first embodiment, an example will be described in which a print job start instruction is input from the main body UI 206.

The situation determination unit 302 obtains information regarding a situation under which an instruction to start an action is input to the image forming system 1 and determines the situation.

That is, since there is a high possibility that the action will be executed in a situation that remains unchanged from the situation under which the instruction to start the action is input, the situation during the execution of the action is estimated by obtaining such information.

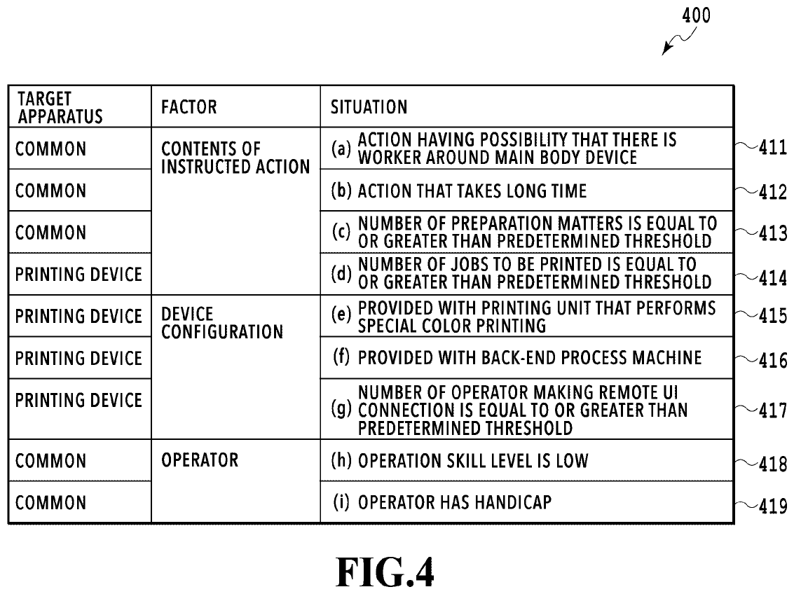

FIG. 4 is a table 400 showing factors that change the warning period and examples of specific situations. As shown in FIG. 4, the factors can be roughly divided into (1) matters caused by the contents of an instructed action, (2) matters caused by the device configuration, and (3) matters caused by the operator.

### (1) Matters Caused by the Content of an Instructed Action.

A specific situation 403 includes the following situations:
(a) a case where a specific action having a possibility that there is a worker around the main body device is instructed (411);
(b) a case where an action that is predicted to take a long action time is instructed (412);
(c) a case where an action is instructed, the number of preparation matters (check items) for performing the action being equal to or greater than a predetermined threshold (413); and
(d) a case where the number of jobs is equal to or greater than a predetermined threshold (in the case of a printing device, a case where the action is a print job, and the number of print jobs is equal to or greater than a predetermined threshold) (414).

### (2) Matters Caused by the Device Configuration.

The specific situation 403 includes the following situations:
(e) in the case of a printing device, a case where the printing device includes a printing unit (special color printing unit 120) that performs special color printing (415);
(f) in the case of a printing device, a case where the printing device includes a back-end process machine (not shown) (416); and
(g) in the case of a printing device, a case where the number of users making a remote UI connection is equal to or greater than a predetermined threshold (417).

### (3) Matters Caused by the Operator.

The specific situation 403 includes the following situations:
(h) a case where the operator has a low operation skill level (418); and
(i) a case where the operator has a handicap (419).

In (a), the specific action means an action that requires operation of the device main body, such as replacing of the roll sheet 111 or ink replacement. In this type of action, there is a high possibility that another worker is near the device main body, and it is necessary to evacuate the worker and provide time for checking safety.

Regarding (b), in an action in which the device runs for a long time, it is necessary to more carefully check the safety of the surroundings. The control unit 204 determines action time based on the number of print jobs and print job setting information. For example, whether the action time becomes long is determined based on whether to perform special color printing in addition to basic color printing, the number of volumes to be supplied and the like.

A specific example of (c) is, for example, a case where many types of inks are used for printing. In this case, a lot of time is required to check the remaining amount of each ink. The control unit 204 determines whether the number of preparation matters (check items) is equal to or greater than a preset threshold based on the print job setting information. In a case where the number of preparation matters (check items) is less than the preset threshold, a reference warning period (three seconds) is set as the warning period, and in a case where the number of preparation matters (check items) is equal to or greater than the preset threshold, the warning period is extended to three seconds or more.

Regarding (d), the control unit 204 controls the action of the device based on a job. In a case where the number of jobs is large, the device is predicted to run for a long time, and it is necessary to more carefully check the safety of the surroundings. A threshold for the number of jobs is preset to, for example, “five” by an administrator. The control unit 204 sets the warning period to the reference warning period (three seconds) in a case where the number of jobs for which start instructions have been input is less than a threshold, and extends the warning period to three seconds or more in a case where the number of jobs for which start instructions have been input is equal to or greater than the threshold.

Regarding (e) and (f), in a case where the image forming device 100 includes the special color printing unit 120 or the back-end process machine (not shown), the number of check matters is larger than in a case where the image forming device 100 includes only the basic color printing unit 130. Thus, it is necessary to secure more time to check the safety of the surroundings.

Regarding (g), the control unit 204 monitors the number of users making a connection to the remote UI 222 (the number of operators who have logged in), sets the warning period to the reference warning period (three seconds) in a case where the number of users making a connection to the remote UI 222 is less than a threshold, and extends the warning period to three seconds or more in a case where the number of users making a connection to the remote UI 222 is equal to or greater than the threshold. The threshold is set to, for example, three people, in advance by the administrator.

Regarding (h) and (i), in a case where information indicating that the operator has a handicap or that the operator has a low operation skill level is set, there is a case where it takes time for the operator to check safety. The control unit 204 obtains the operator's handicap information and skill level information based on the operator's identification information input at the time of login. The warning period is extended in a case where information indicating that the operator has a handicap or information indicating that the skill level is low is set. The setting of handicap information and skill level information will be described later.

Incidentally, for example, in a case where there is a case where the device is activated by two or more people, as information on operators, the control unit 204 may further obtain information on the number of operators.

The situations (d) to (g) above are situations specific to printing devices (image forming device 100). The other situations (a), (b), (c), (h), and (i) are situations applicable to devices in general including printing devices (image forming device 100). For example, the image forming system 1 shown in FIG. 1 is also applicable to actions targeting the sheet feed device 110 and the sheet discharge device 150. Further, (d) is applicable to devices in general other than printing devices in a case where the action is not a printing job.

The description returns to the description of FIG. 3.

The warning period changing unit 303 changes the warning period depending on the situation under which an instruction to start an action is input to the image forming system 1. Specifically, in a case where any of the situations (a) to (i) above applies as a result of the determination by the situation determination unit 302, the warning period is set to be longer than the reference warning period. The warning period changing unit 303 determines time to change the warning period (change time). The following methods can be considered as methods for determining the change time.

Change time is set in advance for each situation, and the change time is determined depending on the situation. For example, change time is associated with and is set for each situation shown in the table 400 of FIG. 4.

Further, in a case where a plurality of situations of the situations (a) to (i) shown in FIG. 4 apply, a value obtained by adding the change time set for each of the plurality of situations that apply is set as change time. In a case where the change time exceeds a predetermined upper limit value due to the addition, the upper limit value is set as change time.

The UI display control unit 304 causes the operation panel 160 and the remote terminal 220 to display a UI screen. The UI screen is provided with information indicating the state of the device, a job list, an action start button, a cancel button, and the like. The UI screen also displays a menu list for selecting a function and can transition to a screen displaying a menu selected by the operator. On each menu screen, settings of various functions, such as registration of user information, print settings, sheet feed settings, and ink supply settings, can be made.

In a case where an instruction to start a print job is issued from the operation panel 160 or the remote terminal 220 via the UI screen, the UI display control unit 304 causes a print execution check screen 600 (FIG. 6) to be displayed. Contents displayed on the print execution check screen 600 will be described later. Further, the UI display control unit 304 synchronizes the lighting/blinking of a warning light with a display on the print execution check screen 600. Specifically, for example, the UI display control unit 304 causes the header of the print execution check screen 600 to coincide with the lighting/blinking pattern of the warning light. The synchronization with the warning light will be described later.

The UI operation control unit 305 performs control so as not to accept any operation of the print execution button 604 displayed on the print execution check screen 600 during the warning period. For example, it is assumed that the print execution button 604 is displayed in a grayed out manner and no signal is generated by operations such as touching or clicking the print execution button 604. Further, during the permissive period provided after the warning period, the UI operation control unit 305 accepts an operation of the print execution button 604. That is, the grayed-out display of the print execution button 604 is canceled to accept an operation by the operator. The UI operation control unit 305 generates an operation signal according to the operation and sends the operation signal to the control unit 204.

Next, the flow of processing executed by the image forming system 1 according to the present embodiment will be described.

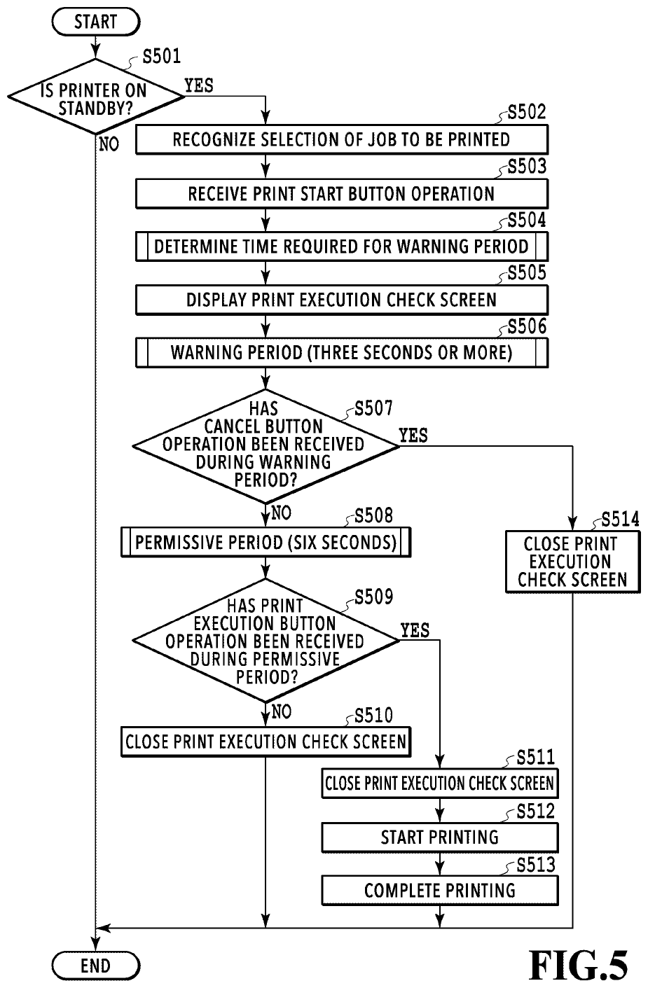

FIG. 5 is a flowchart showing the flow of processing during execution of printing. It should be noted that in the processing shown in the present flowchart, a program stored in the storage unit 205 is called by the control unit 204, expanded into the RAM, and executed by the CPU. The present flowchart starts after the image forming device 100 is activated. In the following description, the symbol “S” means a step.

In S501, the control unit 204 of the control PC 200 obtains information on the state (status) of the image forming device 100 and determines whether the image forming device 100 is on standby. If the image forming device 100 is on standby, the process proceeds to S502. If the image forming device 100 is not on standby, the present flowchart ends.

In S502, the control unit 204 recognizes a job selected by the operator from a job list screen (not shown) displayed on the main body UI 206 (operation panel 160).

In S503, the control unit 204 receives an operation signal for the print start button displayed on the main body UI 206.

In S504, the control unit 204 determines time that the control PC 200 requires for the warning period. How to determine the time required for the warning period will be described later.

In S505, the control unit 204 displays the print execution check screen 600 on the operation panel 160.

FIG. 6 is a diagram showing an example of the print execution check screen 600. The print execution check screen 600 is, for example, displayed in a pop-up manner, but how the print execution check screen 600 is displayed is not limited to this. The print execution check screen 600 may be displayed after transitioning from the screen displayed immediately before the operation of the print start button. On the print execution check screen 600, a situation that has caused the warning period to change (hereinafter referred to as change factor 601) and a warning period 602 are displayed, and a job display region 605 is provided.

In the example of FIG. 6, “SIMULTANEOUS CONNECTION: THREE PEOPLE” is displayed as the change factor 601, “FIVE SECONDS” is displayed as the warning period 602, and “JOB 1, JOB 2” is displayed in the job display region 605 as jobs for which instructions to start execution have been issued.

The time displayed as the warning period 602 is the time required for the warning period determined in S504. The displayed contents as the change factor 601 are information indicating which situation in the table 400 applies. “SIMULTANEOUS CONNECTION: THREE PEOPLE” shown in FIG. 6 as an example indicates that the situation (g) in the table 400 applies. The number of people is information on the number of users making a remote connection (for example, the number of operators logging in to the image forming system 1) obtained by the control unit 204 at the time of the execution start instruction being input.

Further, the print execution check screen 600 is provided with a cancel button 603 and a print execution button 604. The cancel button 603 can be operated during both the warning period and the permissive period after the print execution check screen 600 is displayed. The print execution button 604 is displayed in a grayed out manner and cannot be operated during the warning period. During the subsequent permissive period, the grayed-out display is canceled and the print execution button 604 is controlled so as to be operable.

In a case where the print execution button 604 is operated by the operator, the control unit 204 executes a printing action for the job displayed in the job display region 605. In a case where the cancel button 603 is operated, the print execution check screen 600 is closed by the control unit 204 and transitions to the screen displayed before displaying the print execution check screen 600.

The description returns to the description of FIG. 5.

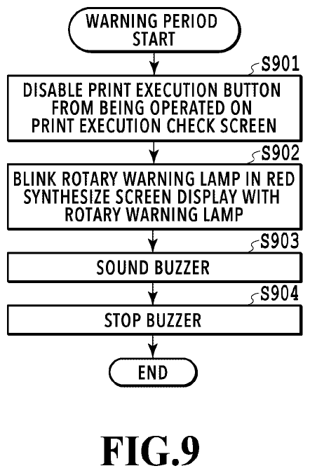

In S506, the control unit 204 starts the warning period. The length of the warning period is the time required for the warning period determined in S504. Reference time for the warning period is, for example, three seconds, change time is set depending on the situation, and the warning period is extended for the change time. Warning processing executed by the control unit 204 during the warning period will be described later (FIG. 9).

In S507, the control unit 204 determines whether an operation signal for the cancel button 603 has been received during the warning period. In a case where the operation signal for the cancel button 603 is received, the control unit 204 does not execute printing, the process proceeds to S514, and the control unit 204 closes the print execution check screen 600. After that, the screen transitions to the screen displayed immediately before the operation of the print start button. In S507, in a case where the operation signal for the cancel button 603 is not received, the process proceeds to S508.

After the warning period ends, in S508, the control unit 204 starts a six-second permissive period.

In S509, the control unit 204 determines whether an operation signal for the print execution button 604 has been received during the permissive period. In S509, in a case where the operation signal for the print execution button 604 is received, the process proceeds to S511, and in a case where the operation signal for the print execution button 604 is not received, the process proceeds to S510.

In S511, the print execution check screen 600 is closed by the control unit 204 and transitions to the screen displayed immediately before the operation of the print start button. In S512, the control unit 204 then starts print processing. In S513, in a case where the print processing is completed, the control unit 204 ends the device action and ends the process according to the present flowchart.

In S509, in a case where the operation signal for the print execution button 604 is not received, the control unit 204 does not execute the print processing, and in S510, the control unit 204 closes the print execution check screen 600. After that, the screen transitions to the screen displayed immediately before the operation of the print start button and the process according to the present flowchart ends.

Here, the process of determining the time required for the warning period in S504 will be described.

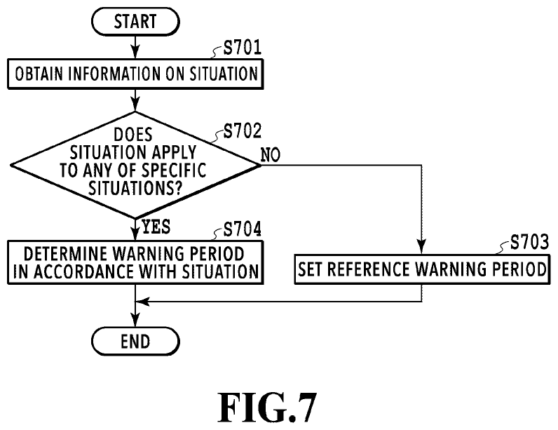

FIG. 7 is a flowchart showing the flow of processing for determining time required for the warning period. The process according to the present flowchart is executed by the control unit 204 in S504 of the flowchart shown in FIG. 5.

In S701, the control unit 204 obtains situation-related information at the time of an instruction to start an action being input. The situation-related information includes, for example, the number of operators making a remote connection, operator's handicap information, operator's skill level information, device configuration information, information on the contents of an action (job) for which an instruction to start execution has been issued, job setting information, and the like.

In S702, the control unit 204 determines whether the situation-related information obtained in S701 applies to a specific situation ((a) to (i) in the table shown in FIG. 4) that changes the warning period. In S702, in a case where the situation-related information applies to a specific situation that changes the warning period, the process proceeds to S704, and in a case where the situation-related information does not apply to a specific situation that changes the warning period, the process proceeds to S703.

In S703, the control unit 204 determines the warning period to be reference time (for example, three seconds).

In S704, the control unit 204 determines the warning period (change time) depending on the situation.

In S703 or S704, in a case where the time required for warning is determined, the process according to the present flowchart ends.

In S704, time [seconds] required for the warning period is determined by equation (1) below. In equation (1), the change time is time [seconds] determined depending on the situation.

warning period=reference time (three [seconds])+change time (1)

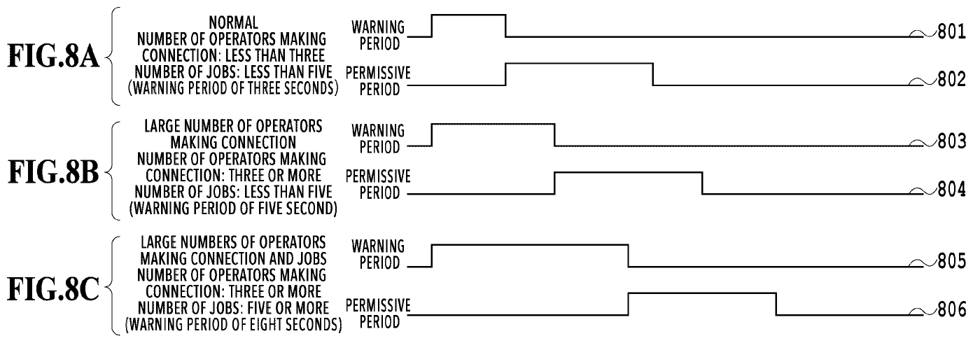

FIGS. 8A to 8C are time charts showing the warning period and the permissive period.

For example, as shown in FIG. 8A, in a case where the number of operators making a connection from the remote terminal 220 is less than three, the number of jobs to be printed is less than five, and none of the other situations falls under any of the specific situations other than the situations (d) and (g) shown in FIG. 4, none of the situations (a) to (i) applies. In that case, there is provided the warning period of three seconds which is the reference time as shown in a time chart 801. After that, there follows the permissive period of six seconds as shown in a time chart 802.

For example, as shown in FIG. 8B, in a case where the number of operators making a connection from the remote terminal 220 is three or more, the number of jobs to be printed is less than five, and none of the other situations falls under any of the specific situations other than the situations (d) and (g) shown in FIG. 4, the condition of the situation (g) applies. In this case, the control unit 204 adds the change time (+two [seconds]) corresponding to the situation (g) to the reference time (three [seconds]). There is provided the warning period of five seconds as shown in a time chart 803, and then there follows the permissive period of six seconds as shown in a time chart 804.

Further, in a case where n change factors are combined, the control unit 204 determines the warning period by equations (2) and (3) described below.

warning period=reference time (three seconds)+change time (2)

change time=(change time due to change factor 1)+(change time due to change factor 2)+ . . . +(change time due to change factor n) (3)

For example, as shown in FIG. 8C, in a case where the number of operators making a connection from the remote terminal 220 is three or more, the number of jobs to be printed is five or more, and none of the other situations falls under any of the specific situations other than the situations (d) and (g) shown in FIG. 4, the conditions of the situations (d) and (g) apply. In this case, the control unit 204 adds the change time (+two [seconds]) corresponding to the situation (g) and the change time (+three [seconds]) corresponding to the situation (d) to the reference time (three [seconds]). As a result, there is provided the warning period of eight seconds as shown in a time chart 805, and there follows the permissive period of six seconds as shown in a time chart 806.

As the number of change factors combined increases, the warning period becomes too long. In order to prevent this, an upper limit value for the warning period may be set, for example, to ten [seconds]. In a case where the warning period calculated by equations (2) and (3) exceeds the upper limit value, the control unit 204 sets the upper limit value as the warning period.

It should be noted that the method of calculating the change time shown as an example is just an example, and the method is not limited to this. It is desirable that an appropriate value be set for the change time depending on the situation causing a change or depending on the target device.

Next, processing executed during the warning period (S506 in FIG. 5) will be described with reference to FIG. 9. FIG. 9 is a flowchart showing the flow of processing executed by the control unit 204 during the warning period.

After the warning period starts, in S901, the control unit 204 disables the print execution button 604 on the print execution check screen 600. At this time, the control unit 204 may display the print execution button 604 in a grayed out manner. At the same time, in S902, the control unit 204 blinks the rotary warning lamp 170 in red and synchronizes a display on the screen with the rotary warning lamp. In S903, the buzzer 180 is sounded. In a case where the warning period ends, in S904, the control unit 204 stops the buzzer 180.

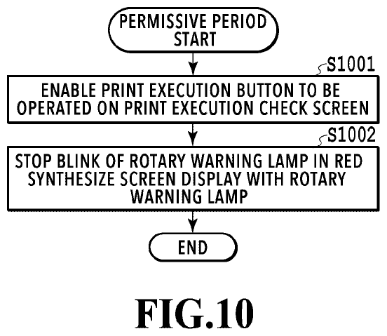

Next, processing executed during the permissive period (S508 in FIG. 5) will be described with reference to FIG. 10. FIG. 10 is a flowchart showing the flow of processing executed by the control unit 204 during the permissive period.

After the permissive period starts, in S1001, the control unit 204 enables the print execution button 604 on the print execution check screen 600. In a case where the print execution button 604 has been displayed in a grayed out manner during the warning period, the grayed-out display is canceled and a normal display state is restored. In a case where the permissive period ends, in S1002, the control unit 204 stops blinking of the rotary warning lamp 170 in red. A display on the screen is also synchronized with the rotary warning lamp.

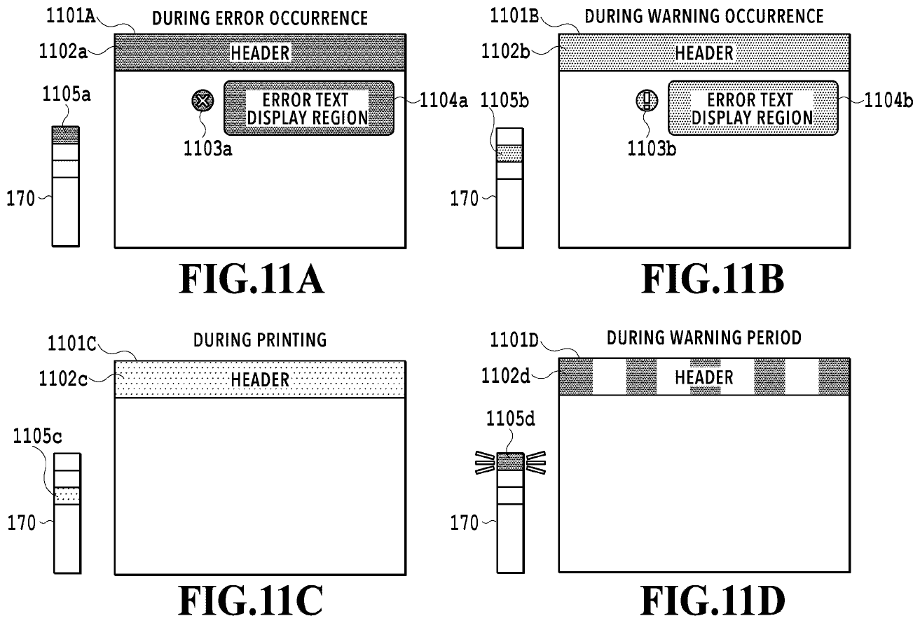

FIGS. 11A to 11D are diagrams showing the synchronization between the rotary warning lamp 170 and the UI screen 1100. FIG. 11A shows the states of a UI screen 1101A and the rotary warning lamp 170 during error occurrence. In a case where the control unit 204 detects the occurrence of an error in the image forming system 1, the control unit 204 lights the rotary warning lamp 170 in red (1105a). In conjunction with this, the control unit 204 changes the display of a header 1102a, an error icon 1103a, and an error text display region 1104a on the UI screen 1101A to red, which is the same color as the lighting color of the rotary warning lamp 170.

FIG. 11B shows the states of a UI screen 1101B and the rotary warning lamp 170 during warning occurrence. During the warning occurrence, the control unit 204 lights the rotary warning lamp 170 in yellow (1105b). In conjunction with this, the control unit 204 changes the display of a header 1102b, an error icon 1103b, and an error message display region 1104b on the UI screen 1101B to yellow, which is the same color as the color of the rotary warning lamp 170.

FIG. 11C shows the states of a UI screen 1101C and the rotary warning lamp 170 during execution of printing. During the execution of printing, the control unit 204 lights the rotary warning lamp 170 in blue (1105c). In conjunction with this, the control unit 204 changes the display of a header 1102c on the UI screen 1101C to blue, which is the same color as the color of the rotary warning lamp 170. No error icon or error text is displayed.

FIG. 11D shows the states of a UI screen 1101D and the rotary warning lamp 170 during the warning period after an instruction to start a printing action is input and before the printing action is started. The control unit 204 blinks the rotary warning lamp 170 in red (1105d). In conjunction with this, the control unit 204 changes the display of a header 1102d on the UI screen 1101D to a red and white striped pattern to express the blink of the rotary warning lamp 170 in red. It should be noted that the striped pattern of the header 1102d on the UI screen 1101D is just an example, and the blink of the rotary warning lamp 170 in red may be expressed in another way. Further, the lighting colors and blinking colors of the rotary warning lamp 170 are also examples and are not limited thereto.

Next, registration of the state of the operator in the image forming system 1 will be described.

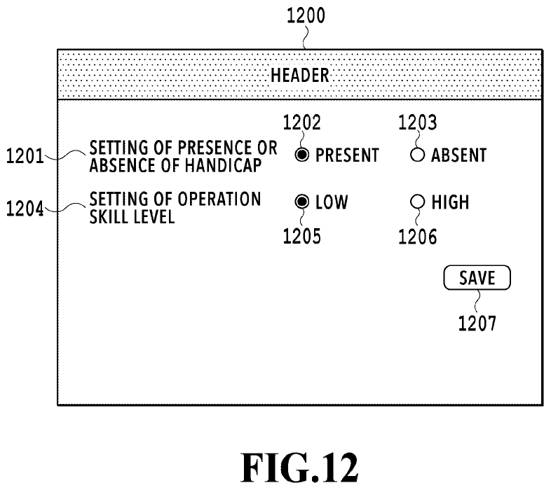

FIG. 12 is a diagram showing an example of an operator state setting screen 1200 displayed on the operation panel 160. In a case where the operator has a handicap, the operator or administrator registers information in advance from the operator state setting screen 1200. In a case where the operator selects an operator information setting menu from a menu list provided on the UI screen after logging in to the image forming system 1, the control unit 204 displays the operator state setting screen 1200. It is assumed that the user ID of the operator and information necessary for login are stored in the storage unit 205 in advance.

As shown in FIG. 12, on the operator state setting screen 1200, an item 1201 for setting the presence or absence of a handicap, an item 1204 for setting an operation skill level, and a save button 1207 are arranged. In the item 1201 for setting the presence or absence of a handicap, a “present” button 1202 and an “absent” button 1203 are arranged side by side. The “present” button 1202 and the “absent” button 1203 are radio buttons, and only one of them can be selected.

In the item 1204 for setting the operation skill level, a “low” button 1205 and a “high” button 1206 are arranged side by side. The “low” button 1205 and the “high” button 1206 are radio buttons, and only one of them can be selected.

If the operator has a handicap, the operator or administrator selects the “present” button 1202 in the item 1201 for setting the presence or absence of a handicap and operates the save button 1207. The control unit 204 records information indicating that a handicap is “present” in association with the user ID of the operator. It should be noted that the information on whether the operator has a handicap is set to either “absent” or “present” in the initial state, and a setting operation on the operator state setting screen 1200 may be performed only in the case of changing the information on whether the operator has a handicap.

In a case where the skill level of the operator is lower than a predetermined standard, the operator or administrator selects the “low” button 1205 in the operation skill level setting item 1204 and operates the save button 1207. The control unit 204 records information indicating that the operation skill level is “low” in association with the user ID of the operator. A criterion for skill level determination may be, for example, a value related to years of experience, or may be a certification test, qualification, or the like. It should be noted that information on the skill level of the operator is set to either “low” or “high” in the initial state, and a setting operation on the operator state setting screen 1200 may be performed only in the case of changing the information on the skill level of the operator.

In this way, the operator's handicap information and skill level information are managed in association with the user ID. As a result, at the time of the operator logging in, it is possible for the control unit 204 to obtain the operator's handicap information and skill level information and determine whether the specific situations that change the warning period apply. It should be noted that the operation of setting the operator's handicap information and skill level information may be performed by a person other than the operator, such as an administrator. In that case, the administrator inputs or selects a target operator and then sets handicap information and skill level information.

As described above, in order to comply with the device safety regulations, the image forming system 1 according to the present embodiment is provided with a warning period and a permissive period after an instruction to start a print job is input and before starting the print job. The control unit 204 extends the warning period depending on the situation at the time of the instruction to start the print job being input. Thus, since sufficient time can be secured for check, it is possible to improve safety at the start of the action of the device. According to the present disclosure, it is possible to comply with the device safety regulations and improve safety at the start of the action of the device.

Incidentally, the example is shown in which in the process of determining the time required for the warning period, the control unit 204 extends the warning period to three seconds or more by adding the change time to the reference time (three seconds). However, the determination method is not limited to this. For example, for factors that do not fall under the situations shown in FIG. 4, the time required for the warning period may be calculated by subtracting predetermined time (the number of seconds) from the upper limit value for the warning period (such as ten seconds). In this case, a value such as three seconds must be set in advance as the lower limit value for the warning period.

Further, factors that change the warning period are not limited to the situations shown in FIG. 4, and another situation may be added. Furthermore, a portion of the situations shown in FIG. 4 may be excluded depending on the device. Additionally, the administrator may make settings to add or delete a factor that changes the warning period.

Further, the warning period may be configured so as to be set directly by the administrator or the like. Thus, the UI operation control unit 305 may cause the display unit 206a to display a setting screen for the setting.

### Second Embodiment

Next, as a second embodiment, a case where an instruction to start a printing action is input from the remote UI 222 will be described. It is difficult for the operator of the remote terminal 220 arranged in another room to grasp the state of the device and the surroundings of the device. Thus, there may be a case where an instruction to start execution is issued from the remote terminal 222 at a time that is inconvenient for the frontline operator or worker. In such a case, it is necessary to secure sufficient time for the operator of the device main body to perform a cancel operation.

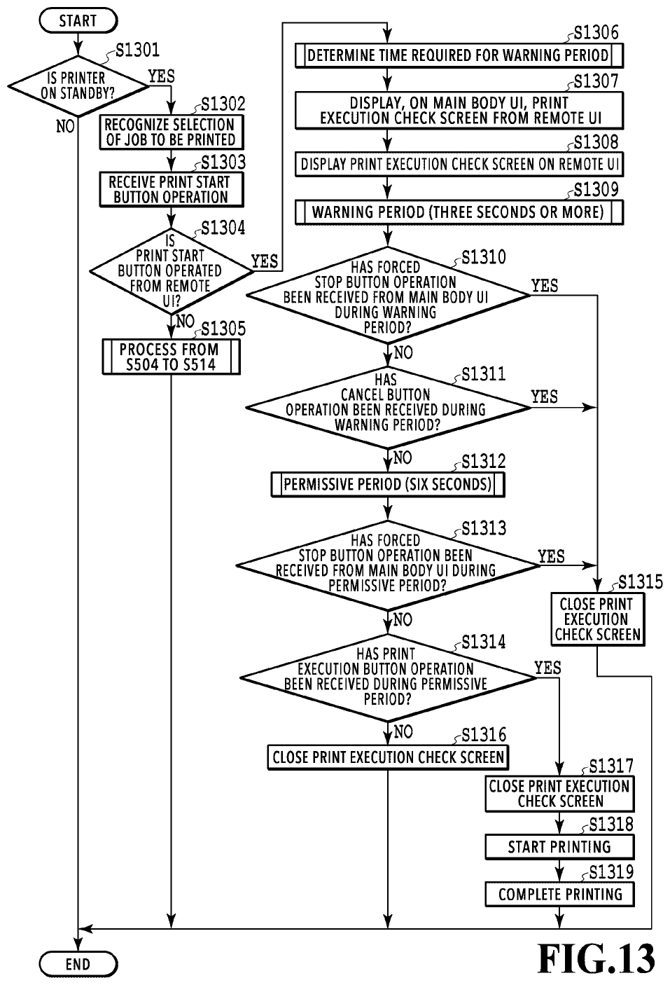

FIG. 13 is a flowchart showing the flow of processing executed by the control unit 204 of the image forming system 1 at the time of the print start button being operated. The present flowchart starts after the image forming device 100 is activated. It should be noted that since the configuration of the image forming system 1 according to the second embodiment is similar to that in the first embodiment (FIGS. 1 to 3), redundant descriptions will be omitted.

In S1301, the control unit 204 of the control PC 200 obtains information on the state (status) of the image forming device 100 and determines whether the image forming device 100 is on standby. In a case where the image forming device 100 is on standby, the process proceeds to S1302. In a case where the image forming device 100 is not on standby, the present flowchart ends.

In S1302, the control unit 204 recognizes a job selected by the operator from the job list screen displayed on the main body UI 206 or the remote UI 222.

In S1303, the control unit 204 receives an operation signal for the print start button from the main body UI 206 or the remote UI 222.

In S1304, the control unit 204 of the control PC 200 determines whether the operation of the print start button in S1303 is an operation executed on the remote UI 222. In a case where the operation of the print start button is not an operation performed on the remote UI 222, the process proceeds to S1305, and the process from S504 to S514 in FIG. 5 is executed. In a case where the operation of the print start button is an operation performed on the remote UI 222, the process proceeds to S1306.

In S1306, the control unit 204 determines time required for the warning period. In a case where the print start button is operated from the remote UI 222, the control unit 204 sets the warning period longer than in a case where the print start button is operated from the main body UI 206. This is because the operator of the remote terminal 220 arranged at a location different from the location of the device main body cannot directly check the surroundings of the device.

In a case where a print start instruction is input from the remote UI 222, the operator of the main body UI 206 checks whether a worker is near the device main body, and in a case where the worker is near the device, it is necessary to evacuate the worker. In such a case, setting a long warning period makes it possible for the operator of the main body UI 206 to perform checking with sufficient time.

In S1306, the control unit 204 calculates time required for the warning period through the procedure shown in the flowchart of FIG. 7. The specific situation in S702 of FIG. 7 is that an operation signal for the print start button is received from the remote UI 222. Further, the control unit 204 determines time required for the warning period based on equation (1) or equations (2) and (3) described above. The reference time is set to three [seconds], and change time (for example, +two [seconds]) is added as one change factor.

In S1307, the control unit 204 causes the main body UI 206 (operation panel 160) to display a print execution check screen 1400 from the remote UI.

In S1308, the control unit 204 causes the remote UI 222 to display the print execution check screen 600 (FIG. 6).

FIG. 14 is a diagram showing an example of the print execution check screen 1400 from the remote UI.

The print execution check screen 1400 from the remote UI is displayed on the main body UI 206 (operation panel 160) in a case where a print start instruction is input from the remote UI 222. In the present embodiment, an example is shown in which the print execution check screen 1400 from the remote UI is displayed in a pop-up manner, but the display form is not limited to this.

As shown in FIG. 14, on the print execution check screen 1400 from the remote UI, a warning period change factor 1401 and a warning period 1402 are displayed, and a job display region 1405 is provided. In the example of FIG. 14, “SIMULTANEOUS CONNECTION: THREE PEOPLE” is displayed as the warning period change factor 1401, “SEVEN SECONDS” is displayed as the warning period 1402, and “JOB 1, JOB 2” is displayed in the job display region 1405 as jobs for which an instruction to start execution has been issued.

Information 1406 indicating that an operation has been performed from the remote UI 222 is displayed on the print execution check screen 1400 from the remote UI. In the example of FIG. 14, a message saying that “printing is about to be executed from the remote UI” is displayed.

The forced stop button 1403 and a printing permit button 1404 are arranged on the print execution check screen 1400 from the remote UI. In a case where the forced stop button 1403 is operated, the control unit 204 cancels a print execution request from the remote UI 222 and closes the print execution check screen 1400 from the remote UI. Further, in a case where the print permission button 1404 is operated, the control unit 204 closes the print execution check screen 1400 from the remote UI and waits for a print execution operation from the remote UI 222. After the print execution check screen 1400 is closed, the screen of the main body UI 206 transitions to the screen before displaying the print execution check screen 1400 from the remote UI.

Time displayed as the warning period 1402 is the time required for the warning period determined in S1306. In a case where a print start instruction is input from the remote UI 222, a warning period longer than that in a case where a print start instruction is input from the main body UI 206 is set. In the example of FIG. 14, reference time of three [seconds]+three or more operators making a simultaneous connection (+two [seconds])+the instruction from the remote UI (+two [seconds])=seven [seconds].

The warning period change factor 1401 is information indicating which situation in the table 400 shown in FIG. 4 applies. “SIMULTANEOUS CONNECTION: THREE PEOPLE” shown as an example indicates that the situation (g) in the table 400 applies. The number of people is information on the number of operators logging in from the remote terminal 220 obtained by the control unit 204 at the time of the execution start instruction being input.

The same time as the warning period 1402 on the print execution check screen 1400 from the remote UI is displayed as the warning period 602 on the print execution check screen 600 displayed on the remote UI 222.

In S1309, the control unit 204 starts the warning period. The length of the warning period is the time required for the warning period determined in S1306. As in the first embodiment, reference time for the warning period is, for example, three seconds, and in a case where change time is set, the warning period is extended for the change time.

During the warning period, in S1310, the control unit 204 determines whether an operation signal for the forced stop button 1403 has been received from the main body UI 206. In a case where the operation signal for the forced stop button 1403 is received, the control unit 204 does not execute printing and the process proceeds to S1315. In S1315, the control unit 204 closes the print execution check screens 600 and 1400 of the main body UI 206 and remote UI 222, respectively. After that, the screen transitions to the screen displayed immediately before the operation of the print start button. In S1310, In a case where the operation signal for the forced stop button 1403 is not received, the process proceeds to S1311.

In S1311, the control unit 204 determines whether an operation signal for a cancel button (the cancel button 603 on the print start screen 600 displayed on the remote UI 222) has been received within the warning period. In a case where the operation signal for the cancel button 603 is received, the control unit 204 does not execute printing and the process proceeds to S1315. In S1315, the control unit 204 closes the print execution check screens 600 and 1400 of the main body UI 206 and remote UI 222, respectively. After that, the screen transitions to the screen displayed immediately before the operation of the print start button.

In a case where the operation signals for the forced stop button 1403 and the cancel button 603 are not received during the warning period (No in S1310 and No in S1311), the process proceeds to S1312.

After the warning period ends, in S1312, the control unit 204 starts a six-second permissive period. In S1313, the control unit 204 determines whether an operation signal for the forced stop button 1403 has been received from the main body UI 206 during the permissive period. In a case where the operation signal for the forced stop button 1403 is received during the permissive period, the control unit 204 does not execute printing and the process proceeds to S1315.

In S1315, the print execution check screens 600 and 1400 of the main body UI 206 and remote UI 222, respectively, are closed by the control unit 204 and transition to the screen displayed immediately before the operation of the print start button. In S1313, in a case where the control unit 204 determines that the operation signal for the forced stop button 1403 is not received during the permissive period, the process proceeds to S1314.

During the permissive period, in S1314, the control unit 204 determines whether an operation signal for the print execution button 604 has been received from the remote UI 222. In a case where the operation signal for the print execution button 604 is received, the process proceeds to S1317. In a case where the operation signal for the print execution button 604 is not received, the control unit 204 does not execute printing and the process proceeds to S1316. In S1316, the print execution check screens 600 and 1400 of the main body UI 206 and remote UI 222, respectively, are closed by the control unit 204 and transition to the screen displayed immediately before the operation of the print start button.

In S1317, the print execution check screens 600 and 1400 are closed by the control unit 204 and then transition to the screen displayed immediately before the operation of the print start button. After that, in S1318, the control unit 204 starts print processing. In S1319, if the print processing is completed, the control unit 204 ends the device action and the present flowchart ends.

As described above, in the second embodiment, in a case where an action start instruction is input from the remote UI 222, the image forming system 1 sets the warning period longer than that in a case where an action start instruction is input from the main body UI 206. This makes it possible to take more time for safety check and to start an action more safely.

### Third Embodiment

Next, a third embodiment will be described.

A change in the warning period is applicable to the case of involving the action of a machine other than printing devices (image forming device 100). As an example, a description will be given of a change in the warning period at the time of an instruction to start sheet conveyance being input.

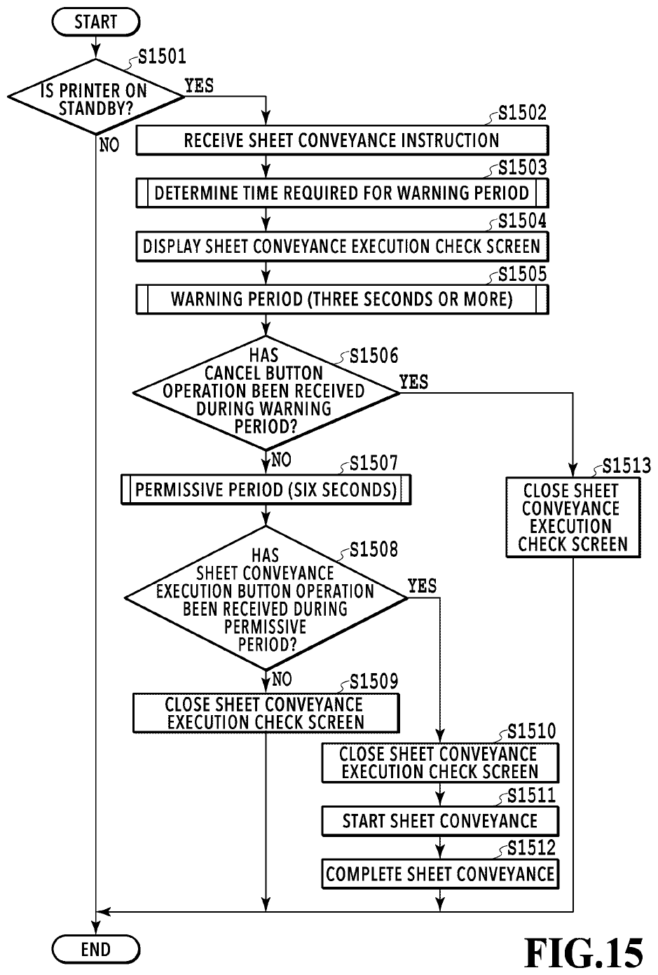

FIG. 15 is a flowchart showing the flow of processing executed by the control unit 204 of the image forming system 1 at the time of a sheet conveyance instruction being input. The present flowchart starts after the image forming system 1 is activated.

In S1501, the control unit 204 of the control PC 200 obtains information on the state (status) of the image forming device 100 and determines whether the image forming device 100 is on standby. In a case where the image forming device 100 is on standby, the process proceeds to S1502. In a case where the image forming device 100 is not on standby, the present flowchart ends.

In S1502, the control unit 204 receives a sheet conveyance instruction from the main body UI 206 (operation panel 160).

In S1503, the control unit 204 determines time required for the warning period. A method for determining the time required for the warning period is the same as the method for determining time required for the warning period in the first embodiment. The control unit 204 determines whether the situation applies to any of the specific situations (a) to (i) shown in FIG. 4 and determines time required for the warning period.

In S1504, the control unit 204 causes a sheet conveyance execution check screen (not shown) to be displayed on the operation panel 160. On the sheet conveyance execution check screen, the warning period change factor 601 and the warning period 602 are displayed and the cancel button 603 is provided as on the print execution check screen 600 in FIG. 6. Further, a sheet conveyance execution button is provided in place of the print execution button 604.

In S1505, the control unit 204 starts the warning period. The length of the warning period is the time required for the warning period determined in S1503. Reference time for the warning period is, for example, three [seconds], and if change time is set, the warning period is extended for the change time.

During the warning period, in S1506, the control unit 204 determines whether an operation signal for the cancel button 603 on the sheet conveyance execution check screen has been received. In a case where the operation signal for the cancel button 603 is received, the control unit 204 does not execute printing, the process proceeds to S1513, and the control unit 204 closes the sheet conveyance execution check screen. After that, the screen transitions to the screen displayed immediately before sending the sheet conveyance instruction. In S1506, in a case where the operation signal for the cancel button 603 is not received, the process proceeds to S1507. Warning processing executed by the control unit 204 during the warning period is similar to the warning processing in the first embodiment (FIG. 9).

After the warning period ends, in S1507, the control unit 204 starts a 6-second permissive period. During the permissive period, in S1508, the control unit 204 determines whether an operation signal for the sheet conveyance execution button has been received. In S1508, in a case where the operation signal for the sheet conveyance execution button is received, the process proceeds to S1510, and in a case where the operation signal for the sheet conveyance execution button is not received, the process proceeds to S1509.

In S1510, the sheet conveyance execution check screen is closed by the control unit 204 and transitions to the screen displayed immediately before sending the sheet conveyance instruction. In S1511, the control unit 204 then controls the sheet feed device 110 and the sheet discharge device 150 to start a sheet conveyance action. In S1512, in a case where sheet conveyance is completed, the control unit 204 ends the device action and the process according to the present flowchart ends.

In S1508, in a case where the operation signal for the sheet conveyance execution button is not received, the control unit 204 does not execute sheet conveyance processing and, in S1509, closes the sheet conveyance execution check screen. After that, the screen transitions to the screen displayed immediately before sending the sheet conveyance instruction, and the process according to the present flowchart ends.

As described above, it is possible to provide devices other than the image forming device 100 (the sheet feed device 110, the sheet discharge device 150, the back-end process machine, and other devices subject to the device safety regulations) with a warning period suitable for the situation at the time of an instruction to start an action being issued.

It should be noted that in the third embodiment, the case has been described where a sheet conveyance instruction is input from the main body UI 206, but the warning period can also be extended depending on the situation in a case where a sheet conveyance instruction is input from the remote UI 222. Further, in a case where a sheet conveyance instruction is input from the remote UI 222, it is desirable to set the warning period longer than that in the case where a sheet conveyance instruction is input from the main body UI 206 as in the second embodiment.

Further, the display contents and display forms of the screens displayed in each embodiment are merely examples and can be modified as appropriate.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-089747, filed May 31, 2023, which is hereby incorporated by reference wherein in its entirety.

What is claimed is:

1. A controlling apparatus for controlling a device provided with a warning period before starting an action, the controlling apparatus comprising:
an acceptance unit configured to accept an instruction to start the action; and
a changing unit configured to change the warning period in accordance with a situation under which the action is executed.

2. The controlling apparatus according to claim 1, further comprising:
an obtaining unit configured to obtain information about a situation of the device at a time that the acceptance unit accepts the instruction to start the action as the situation under which the action is executed.

3. The controlling apparatus according to claim 2, wherein the changing unit changes the warning period based on at least one of the following pieces of information as the situation under which the action is executed: whether the action includes work around a main body of the device; time to execute the action; a number of preparation matters for executing the action; and a number of jobs related to the action.

4. The controlling apparatus according to claim 1, wherein the changing unit changes the warning period in accordance with a configuration of the device as the situation under which the action is executed.

5. The controlling apparatus according to claim 4, wherein
the device is a printing device, and
the changing unit changes the warning period based on at least one of the following factors: presence or absence of a printing unit performing special color printing;
presence or absence of a back-end process machine; and a number of users making a remote UI connection.

6. The controlling apparatus according to claim 1, wherein the changing unit changes the warning period in accordance with information about an operator of the device as the situation under which the action is executed.

7. The controlling apparatus according to claim 6, wherein the changing unit changes the warning period based on at least one of an operation skill level of the operator, information indicating whether the operator has a handicap, and a number of the operators.

8. The controlling apparatus according to claim 7, wherein
the controlling apparatus comprises a first registration unit configured to register handicap information on the operator, and
the changing unit obtains the registered handicap information on the operator and changes the warning period in accordance with the obtained handicap information.

9. The controlling apparatus according to claim 7, wherein
the controlling apparatus comprises a second registration unit configured to register an operation skill level of the operator, and
the changing unit obtains the registered operation skill level of the operator and changes the warning period in accordance with the obtained operation skill level.

10. The controlling apparatus according to claim 1, further comprising a determination unit configured to determine time required for the warning period.

11. The controlling apparatus according to claim 10, wherein the determination unit determines time required for the warning period based on change time set in advance for each situation causing the warning period to change.

12. The controlling apparatus according to claim 10, wherein in a case where the acceptance unit accepts the instruction from a remote terminal, the determination unit sets the warning period longer than that in a case where the acceptance unit accepts the instruction from an operation unit provided in a main body of the device.

13. The controlling apparatus according to claim 10, wherein in a case where there are a plurality of factors that change the warning period, the determination unit adds change time for each of the factors to determine time required for the warning period.

14. The controlling apparatus according to claim 13, wherein in a case where the addition makes the change time equal to or greater than a predetermined upper limit value, the upper limit value is set as the change time.

15. The controlling apparatus according to claim 1, further comprising a display control unit configured to display a check screen for checking a state of the device during the warning period,
wherein the display control unit displays a factor that has changed the warning period on the check screen.

16. The controlling apparatus according to claim 15, wherein the display control unit further displays time for the warning period on the check screen.

17. The controlling apparatus according to claim 15, further comprising a warning light control unit configured to blink a warning light during the warning period,
wherein the display control unit synchronizes a blink of the warning light with a display on the check screen.

18. The controlling apparatus according to claim 1, further comprising an operation control unit configured to perform control so as not to accept an operation to execute the action during the warning period.

19. The controlling apparatus according to claim 18, wherein during a permissive period provided after the warning period,
the operation control unit performs control to accept an operation to execute the action.

20. The controlling apparatus according to claim 1, wherein the action is a printing action.

21. The controlling apparatus according to claim 1, wherein the action is a sheet conveyance action.

22. The controlling apparatus according to claim 1, wherein the changing unit extends the warning period.

23. A method of controlling a device provided with a warning period before starting an action, the method comprising:
accepting an instruction to start the action; and
changing the warning period in accordance with a situation under which the action is executed.

24. A non-transitory computer readable storage medium storing a program which causes a computer to execute a method of controlling a device provided with a warning period before starting an action, the method comprising:
accepting an instruction to start the action; and
changing the warning period in accordance with a situation under which the action is executed.
